(19) United States
(12) Patent Application Publication
(10) Pub. No.: US 2008/0088147 A1
(43) Pub. Date: Apr. 17, 2008

(54) Luggage floor box of a vehicle

(76) Inventor: Won Jae Choi, Yongin-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/606,200

(22) Filed: Nov. 28, 2006

(30) Foreign Application Priority Data
Oct. 12, 2006 (KR) 10-2006-0099438

(51) Int. Cl. B60N 2/02

(52) U.S. Cl. 296/37.16; 296/65.09

(57) ABSTRACT

The present invention relates to a luggage floor box. A luggage floor box of a vehicle including: a receiving part which is formed by being downwardly indented at a rear side of a floor panel so as to provide a receiving space; and at least one partition disposed within the receiving part in a lengthwise direction thereof so as to divide the receiving space into a plurality of receiving spaces. The receiving part is configured to house a center seat of the last row which is mounted on the floor panel.

### CROSS-REFERENCE TO RELATED APPLICATION

This application claims priority to Korean Patent Application No. 10-2006-0099438 filed in the Korean Intellectual Property Office on Oct. 12, 2006, the disclosure of which is incorporated herein by reference.

### BACKGROUND OF THE INVENTION

a) Field of the Invention

The present invention relates to a luggage floor box in a vehicle. In particular, the present invention relates to a luggage floor box which is mounted in the cargo compartment of a sport utility vehicle.

b) Description of the Related Art

Recently, consumers have been using a recreational vehicles or a SUVs (Sport Utility Vehicle) at an increasing rate.

In a SUV, the seats in the second row are configured to be fully flat so as to expand a luggage room. Additionally, various items are disposed in a floor box which is provided in the cargo compartment.

At this time, in the conventional partition structure, there is a problem in that the space for containing items having various sizes is not sufficient. In addition, the conventional luggage box provided to a trunk of a vehicle cannot efficiently use a space.

Therefore, the present invention provides sufficient space for storing items of various sizes.

### SUMMARY OF THE INVENTION

The present invention provides a luggage floor box in a vehicle which can receive items of various sizes.

The present invention also provides a luggage floor box in a vehicle which minimizes movement and noise of the stored items. Additionally, the board which is located on top of the luggage floor box is designed such that the flooring of the cargo compartment looks aesthetically pleasing.

An exemplary embodiment of the present invention provides a luggage floor box of a vehicle which includes: a receiving part which is formed by being downwardly indented at a rear side of a floor panel so as to provide a receiving space; and at least one partition disposed within the receiving part in a lengthwise direction thereof so as to divide the receiving space into a plurality of receiving spaces. The receiving part is configured to house a center seat of the last row which is mounted on the floor panel.

The luggage floor box may further include a board which is supported by an upper end of the erected partition and the floor panel near the receiving part. The board covers at least one receiving space among the plurality of the receiving parts which are divided by the partition.

The receiving part may include an overturn prevention member for preventing an overturn of the partition.

The overturn prevention member may be formed at an inner wall of the receiving part, and comprises a blocking protrusion and a stopper. The erected partition is interposed between the blocking protrusion and the stopper.

At least one hinge member which supports the rotatable partition may be provided on the bottom of the receiving part.

The hinge member may include a hinge.

A sectional shape of the blocking protrusion may be a semicircle such that the partition can easily rotate with respect to the hinge member.

The stopper may be formed to block movement of the partition.

The center seat may be housed in a receiving space formed between the two partitions such that the receiving space in which the center seat is housed and other receiving spaces are separated by the partition.

The receiving part may be formed integrally with a rear end of the floor panel and is extended backward.

### BRIEF DESCRIPTION OF THE DRAWINGS

FIG. 1 is a perspective view of a luggage floor box in a state that a cover thereof is opened.

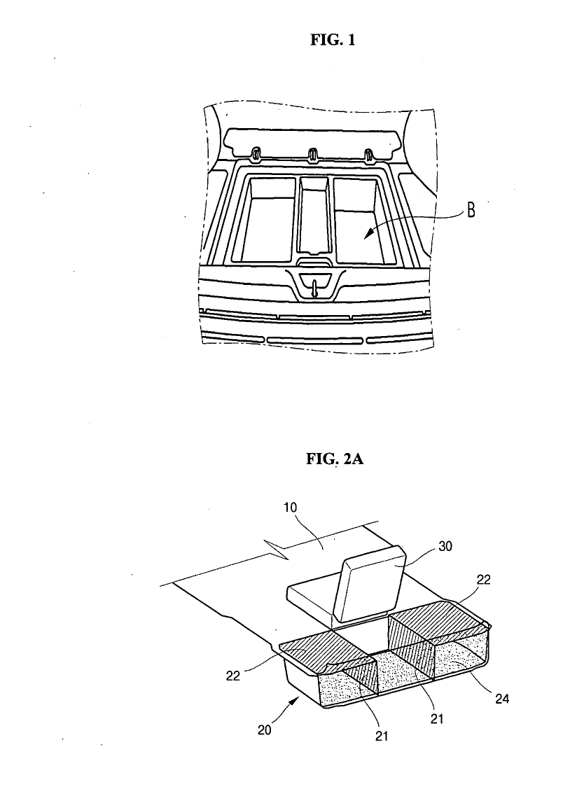

FIG. 2A to FIG. 2C are perspective views showing states of a receiving part according to the use of a center seat in a luggage floor box of a vehicle according to an exemplary embodiment of the present invention.

FIG. 3A and FIG. 3B are perspective views of a center seat in a luggage floor box of a vehicle according to an exemplary embodiment of the present invention.

FIG. 4 is an enlarged partial perspective view showing an overturn prevention member and a hinge member in a luggage floor box of a vehicle according to an exemplary embodiment of the present invention.

### DETAILED DESCRIPTION OF THE INVENTION

An exemplary embodiment of the present invention will hereinafter be described in detail with reference to the accompanying drawings.

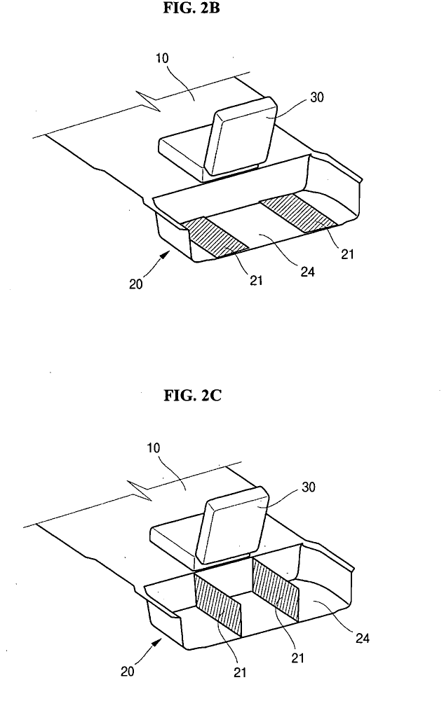

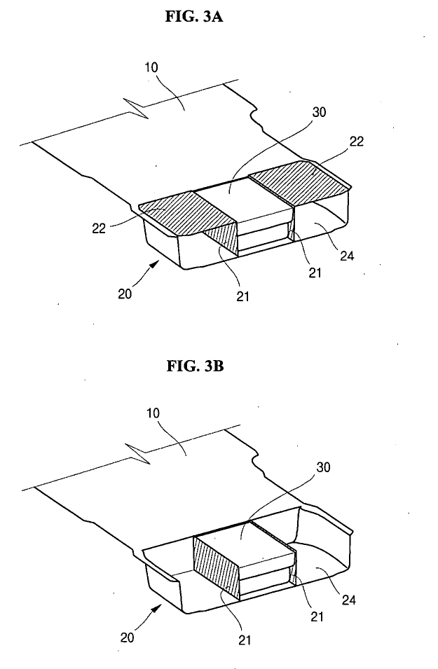

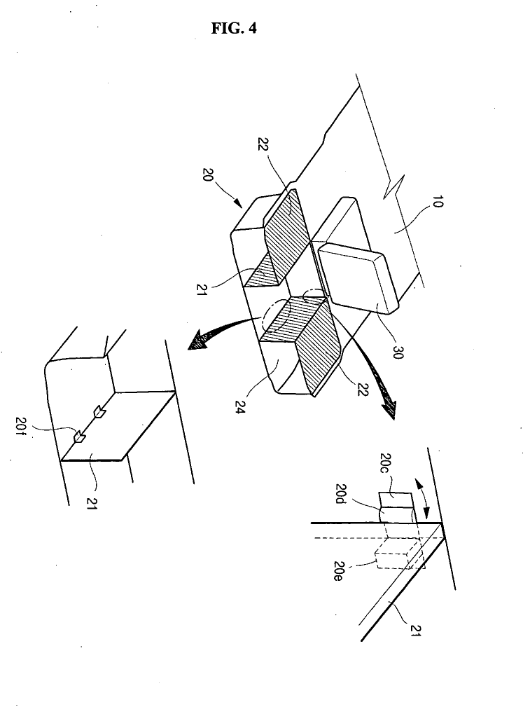

FIG. 2A to FIG. 2C are perspective views showing states of a receiving part according to use of a center seat in a luggage floor box of a vehicle according to an exemplary embodiment of the present invention. FIG. 3A and FIG. 3B are perspective views different states of a center seat in a luggage floor box of a vehicle according to an exemplary embodiment of the present invention. FIG. 4 is an enlarged partial perspective view showing an overturn prevention member and a hinge member in the luggage floor box of a vehicle according to an exemplary embodiment of the present invention. For ease of description, a part forming a rear inner wall of a receiving space is omitted in FIG. 2B to FIG. 4.

Referring to the drawings, a luggage floor box according to an exemplary embodiment of the present invention includes a receiving part 20 and at least one partition 21 which is disposed within the receiving part 20 along a lengthwise direction thereof. A luggage floor box may further include at least one board 22 which is supported by an upper end of the partition 21.

As shown in FIG. 2A to FIG. 2C, the receiving part 20 is formed integrally with a rear end of a floor panel 10 and is then extended backward, and is formed to be downwardly indented so that an upper surface thereof is opened. Accordingly, a receiving space with a predetermined size which can contain various items is formed.

The partition 21 is a rectangular plate, and is disposed within the receiving part 20 along a lengthwise direction thereof so as to partition the receiving space of the receiving part 20. In addition, as shown in FIG. 4, the partition 21 are configured to rotate in the receiving part 20 by a hinge member such as a hinge 20f mounted to a bottom 24 of the receiving part 20 so as to lie down on the bottom 24 or to erect.

The edges of the board 22 are supported by an upper end of the erected partition 21 and the floor panel 10 near the receiving part 20. The board 22 is mounted to cover at least one receiving space among a plurality of receiving spaces in the receiving part 20 which is partitioned by the partition 21. Accordingly, items can be laid on an upper surface of the board 22. A separate fixing member may be provided in order to fix the board 22, and the board 22 may be supported by a step (not shown) which is formed along an edge of the receiving part 20 to contact the floorpanel 10. The board 22 may be selectively used according to a luggage type and purpose of a receiving space.

In addition, as shown in FIG. 4, an overturn prevention member for preventing the overturn of the partition 21 is provided at an upper inner wall of the receiving part 20. The overturn prevention member includes a support plate 20c, a blocking protrusion 20d which is formed at one side of an upper portion of the support plate 20c, and a stopper 20e which is formed at the second side of an upper portion of the support plate 20c. Here, the support plate 20c may become an inner wall of the receiving part 20. Accordingly, the overturn prevention member is formed at an inner wall of the receiving part 20, and includes the blocking protrusion 20d and the stopper 20e between which the partition 21 is interposed.

The blocking protrusion 20d and the stopper 20e may be formed on an inner wall of the receiving part 20, and the partition 21 may be interposed there between. In this case, the inner wall is the support plate 20c.

It is preferable that the blocking protrusion 20d is formed in a semicircular shape with a predetermined curvature such that an upper end of the partition 21 can easily move on an outer surface of the blocking protrusion 20d, and the stopper 20e may be formed in a rectangular block having a predetermined width and length so as to prevent undesired movement of the partition 21.

Meanwhile, as shown in FIG. 3A and FIG. 3B, a center seat 30 of a last row which is mounted on the floor panel 10 may be housed in the receiving part 20. Since the center seat 30 is housed in a first receiving space which is formed between the two the partitions 21, the other receiving space can be partitioned by the partition 21 and can be separately used.

The operations of a luggage floor box according to an exemplary embodiment of the present invention will be explained hereinafter.

Referring to FIG. 2A, the two partitions 21 may be disposed on the bottom 24 of the receiving part 20 so as to divide the receiving space into three spaces. The board 22 is disposed on the receiving part 20 so as to cover two receiving spaces on both sides. In this case, luggage may be positioned on the board 22 and may be disposed in a center space of the receiving part 20. That is, a luggage having a rectangular shape may be stored in the center receiving space, and a luggage having a long rectangular shape may be disposed on the board 22. Things may also be stored in the spaces which are covered by the board 22.

Referring to FIG. 2B and FIG. 4, the partition 21 may be folded to contact the bottom 24 of the receiving part 20 by rotating with respect to the hinge 20f, thereby, providing one long receiving space in which a long rectangular luggage can be stored.

Referring to FIG. 2C, the two partitions 21 may be erected without the board 22, and in this state, the receiving part 20 provides three receiving spaces in which a luggage with a square or a rectangular shape can be stored respectively.

Meanwhile, as shown in FIG. 3A and FIG. 3B, the center seat 30 may be folded and stored into the receiving part 20. Referring to FIG. 3A, the partitions 21 are erected, the center seat 30 is housed in the receiving space formed between the two partitions 21, and the boards 22 are put on the receiving spaces on both sides. In this state, a luggage with a long rectangular shape can be positioned on the board 22. It is also possible that small things may be positioned in the receiving spaces covered by the board 22.

Referring to FIG. 3B, the center seat 30 is housed in the receiving part 20, and the partition 21 are erected. In this case, two receiving spaces are formed at both sides of the receiving part 20, and things can be stored in these receiving spaces.

When the partition 21 rotates, as shown in FIG. 4, an upper end of the partition 21 moves to ride an outer surface of the blocking protrusion 20d, and is then blocked by the stopper 20e so as to be stopped. In order to fold the partition 21 in a horizontal direction, the partition 21 is downwardly rotated, and simultaneously an upper end of the partition 21 moves downwardly while riding an outer surface of the blocking protrusion 20d.

Meanwhile, in FIG. 2A and FIG. 3A, the board 22 may be fixed to the floor panel 10 by a separate fixing member (not shown). In this case, movement of luggage and noise in the receiving part 20 can be minimized. Additionally, since the receiving part 20 is covered by the board 22, the external appearance of the board blends in well aesthetically with the vehicle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A luggage floor box of a vehicle, comprising:
a receiving part which is formed by being downwardly indented at a rear side of a floor panel so as to provide a receiving space; and
at least one partition disposed within the receiving part in a lengthwise direction thereby dividing the receiving space into a plurality of receiving spaces,
wherein the receiving part is configured to house a center seat of the last row which is mounted on the floor panel.

2. The luggage floor box of claim 1, further comprising a board which is supported by an upper end of the erected partition and the floor panel near the receiving part, and covers at least one receiving space among the plurality of the receiving parts which are divided by the partition.

3. The luggage floor box of claim 1, wherein the receiving part comprises an overturn prevention member.

4. The luggage floor box of claim 3, wherein the overturn prevention member is formed at an inner wall of the receiving part, and comprises a blocking protrusion and a stopper, where the erected partition is interposed between the blocking protrusion and the stopper.

5. The luggage floor box of claim 3, wherein at least one rotatable hinge member which supports the partition is provided on a bottom of the receiving part.

6. The luggage floor box of claim 5, wherein the hinge member comprises a hinge.

7. The luggage floor box of claim 5, wherein a sectional shape of the blocking protrusion is a semicircle.

8. The luggage floor box of claim 5, wherein the stopper is formed to block movement of the partition.

9. The luggage floor box of claim 4, wherein at least one rotatable hinge member which supports the partition is provided on a bottom of the receiving part.

10. The luggage floor box of claim 9, wherein the hinge member comprises a hinge.

11. The luggage floor box of claim 9, wherein a sectional shape of the blocking protrusion is a semicircle.

12. The luggage floor box of claim 9, wherein the stopper is formed to block movement of the partition.

13. The luggage floor box of claim 1, wherein the center seat is housed in a receiving space formed between two partitions.

14. The luggage floor box of claim 1, wherein the receiving part is formed integrally with a rear end of the floor panel and is extended backward.
